(19) United States
(12) Patent Application Publication
(10) Pub. No.: US 2023/0286337 A1
(43) Pub. Date: Sep. 14, 2023

(54) APPARATUS AND METHOD FOR TRANSPORTING ARCHES

(71) Applicant: Lorne Juday, Rodney, MI (US)

(72) Inventor: Lorne Juday, Rodney, MI (US)

(21) Appl. No.: 18/117,244

(22) Filed: Mar. 3, 2023

Related U.S. Application Data
(60) Provisional application No. 63/317,603, filed on Mar. 8, 2022.

(51) Int. Cl. B60D 1/07; B60D 1/52

(52) U.S. Cl. CPC B60D 1/075; B60D 1/52

(57) ABSTRACT

A transport adapter connectable to a wheeled log arch so that the log arch may be easily mounted in a vertical, wheels-off-the-ground position on a vehicle hitch receiver for transport to a remote work site. The invention also includes the method for using the transport adapter to mount and transport the adapter-equipped log arch on the vehicle hitch receiver.

### RELATED APPLICATIONS/PRIORITY BENEFIT CLAIM

This application claims priority to provisional application Ser. No. 63/317,603 filed Mar. 8, 2022, which is incorporated herein by reference.

### FIELD

The present invention relates to the field of low impact logging operations and the use of “log arches” used for hauling logs in such operations.

### BACKGROUND

Log arches are wheeled log-handling devices comprising a frame mounted on two wheels for pulling or hauling a log around a work site. The rear part of the frame includes an arch which extends above the wheels, and is provided with means such as grappling tongs for hoisting a log up for suspension under the arch. The forward part of the frame includes a main beam extending forward from the arch and wheels to be connected to a hauling device such as a pull handle, winch ring, or vehicle hitch adapter for slowly pulling the log arch and a suspended log by hand, winch, or towing. Commercially manufactured log arches have been in use since about 1996.

Low impact logging operations are often comprised of a single person or small group work crews at the landowner or local small business level. Log arches may be transported to the field by being towed with the hitch attachment behind a vehicle, by being loaded into the bed of a pickup truck, or by being placed onto a separate tow-behind trailer, but these methods all have disadvantages. For example, log arches are designed for moving heavy logs at low speeds through the woods, and are not rated for high speed transport on roads; small crews need pickup and trailer beds for other needed equipment; and trailers often need to be loaded with logs upon leaving the logging area.

### BRIEF SUMMARY

In the present invention, the log arch is provided with a vehicle transport adapter projecting upwardly at a rear end of the log arch frame, at or behind the arch and the wheels. The transport adapter can be attached to the hitch receiver on a vehicle after the hitch (usually a ball hitch) is removed from the receiver, such that the log arch can be conveyed from place to place with the main beam projecting vertically upward and the wheels off the ground. In the preferred form, the transport adapter is removably attached to the log arch, for example by being swapped out with log-handling features removably attached to the rear of the log arch frame behind the arch.

In one form, the vehicle transport adapter comprises an angled, generally L-shaped structure, with a first spacer arm extending horizontally rearward from the frame behind the arch and wheels, and with a second hitch arm that extends vertically upward from the spacer arm to a point above the arch, when the log arch is on the ground. An outer end of the hitch arm is configured to mate with a vehicle hitch receiver in a generally horizontal orientation when the arch is rotated with the main beam to a vertical position, such that the spacer arm and the log arch frame are oriented generally vertically above the hitch with the log arch wheels off the ground. A log arch trailer mounted in this fashion can be moved anywhere by the vehicle at high speeds, including over highways.

In a further form, the spacer and hitch arms may be hinged relative to one another, so that one or the other of the arms can be rotated downwardly from the transport adapter to be substantially in-line with the other arm, in order to help make the initial engagement between the log arch and the vehicle's hitch receiver. In such a hinged form, a tension/compression brace extending between the spacer and hitch arms on the transport adapter can include a latching mechanism that latches to connect the arms in the L-shaped load-bearing configuration when the log arch is lifted to the vertical position on the vehicle hitch receiver. In this form, the hitch arm on the transport adapter may be connected to the vehicle hitch receiver before the spacer arm is connected to the log arch, and vice versa.

In another form, the spacer arm may include a collar or shoulder to help support the weight of the log arch while it is being vertically transported.

In a further form, methods are disclosed for initially engaging a log arch to a vehicle hitch using the transport adapter, and for transporting a log arch in a vertical, wheels-off-the-ground position behind a vehicle.

These and other features and advantages of the invention will become apparent from the detailed description below, in light of the accompanying drawings.

### BRIEF DESCRIPTION OF THE DRAWINGS

FIG. 1 is a rear perspective view of a log arch 10 of known type.

FIG. 2 is similar to FIG. 1, with a transport adapter 100 according to a preferred embodiment of the invention shown removably attached to the rear end of the log arch.

FIG. 2A is similar FIG. 2 but shows an embodiment in which, a transport adapter 100a according to a preferred embodiment of the invention is shown permanently attached to the rear end of the log arch 10.

FIG. 2B is similar FIG. 2 but shows an embodiment in which, a transport adapter 100b according to a preferred embodiment of the invention is shown attached to the rear end of the log arch 10.

FIG. 3 is a side elevation view of the adapter-equipped end of the log arch positioned to be connected to a vehicle hitch receiver.

FIG. 3A is similar to FIG. 3, but with the adapter fully connected to the hitch receiver.

FIG. 4 is a side elevation of the log arch mounted vertically on the vehicle hitch receiver behind the vehicle.

FIG. 5 shows a close-up view of the transport adapter of FIG. 2, but modified with a hinge mechanism, latching brace, and arch support collar.

FIG. 6 shows the modified transport adapter of FIG. 5 being initially engaged with the vehicle hitch receiver and log arch.

FIG. 7 shows the modified transport adapter of FIG. 5 fully engaged with the vehicle hitch receiver and log arch, with the log arch supported vertically on the receiver.

### DETAILED DESCRIPTION

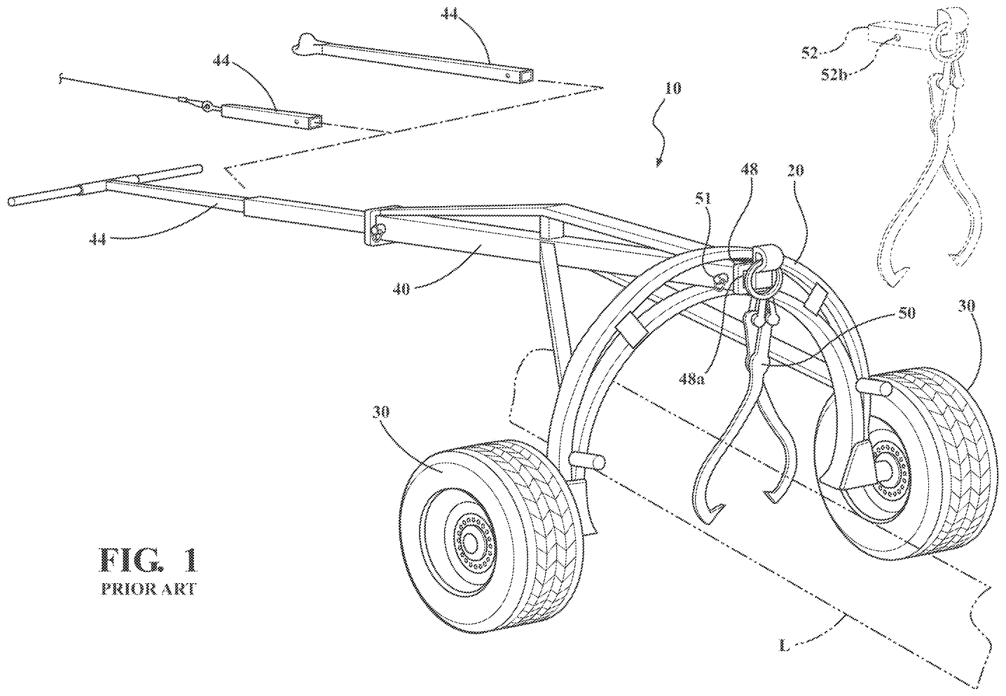

Referring first to FIG. 1, a commercially available log arch 10 of known type is shown in rear perspective view, equipped with a log-handling device 50. Log arch 10 in the illustrated example is representative of a LogRite® “fetching arch” made by the LogRite Tools company, but it may be taken to represent other known and available types of log arch of similar structure.

Log arch 10 comprises a sturdy metal frame capable of supporting a heavy log L (shown in phantom lines) and includes a frame arch 20 and associated wheels 30 at a rear end, and a main beam 40 extending forwardly of the arch and the wheels to a forward end 42. Forward end 42 of the main beam 40 is configured to include or to be attached to one or more known types of log-hauling device 44 such as a manual pull handle, a winch attachment, or a vehicle hitch connector. Some log arches may have forward ends configured for only a single style of hauling, but modular haul attachments are believed to be more common.

The rear end 48 of log arch 10 supports a known type of log-handling device 50 such as log-grappling tongs in order to lift and support an end of a timbered log L off the ground. Once the log L is supported as shown, the log arch 10 and the attached log L may be slowly pulled from the forward end 42 by the preferred hauling means in known manner, usually with the rear end of the log dragging on the ground behind the front tongs-supported end of the log. Typical logs may weigh hundreds or even a thousand or more pounds.

In the illustrated example, rear end 48 of the log arch frame comprises a rear end of the main beam 40, terminating at or behind the arch 20 near the crown of the arch for maximum elevation of the log-handling device 50 above the wheels 30. Log-handling device 50 is shown removably attached to the frame's rear end 48, which is shown with a square socket 48a similar to a vehicle hitch receiver for receiving a square-tubed connecting tongue 52 from the device 50, and for securing it in place with a thick steel locking pin 51 inserted through aligned holes 48b, 52b in known manner.

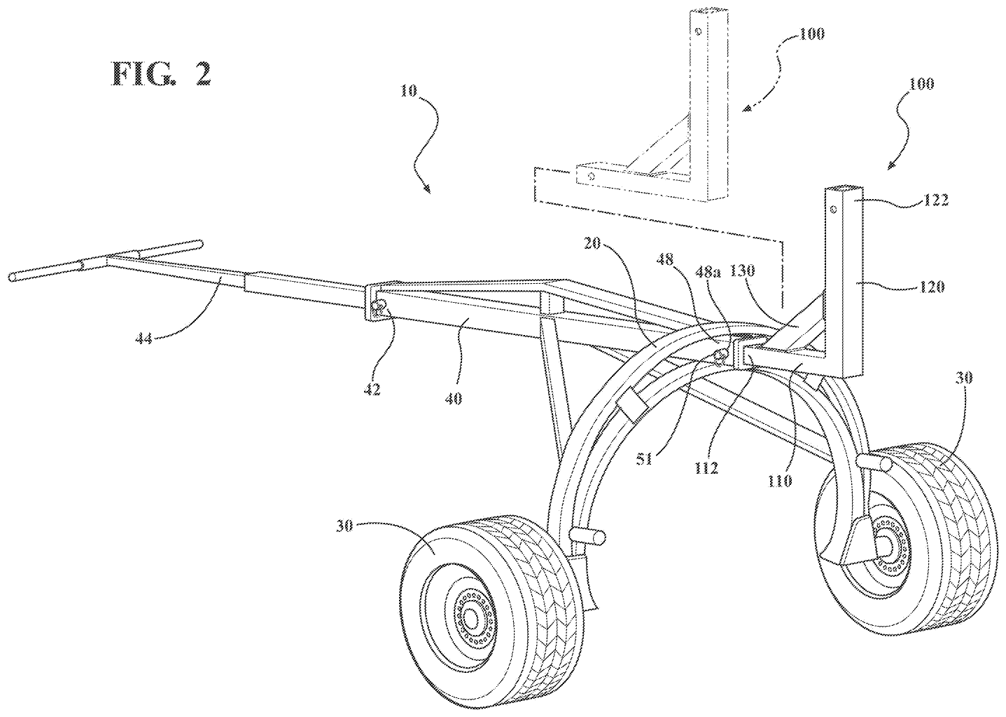

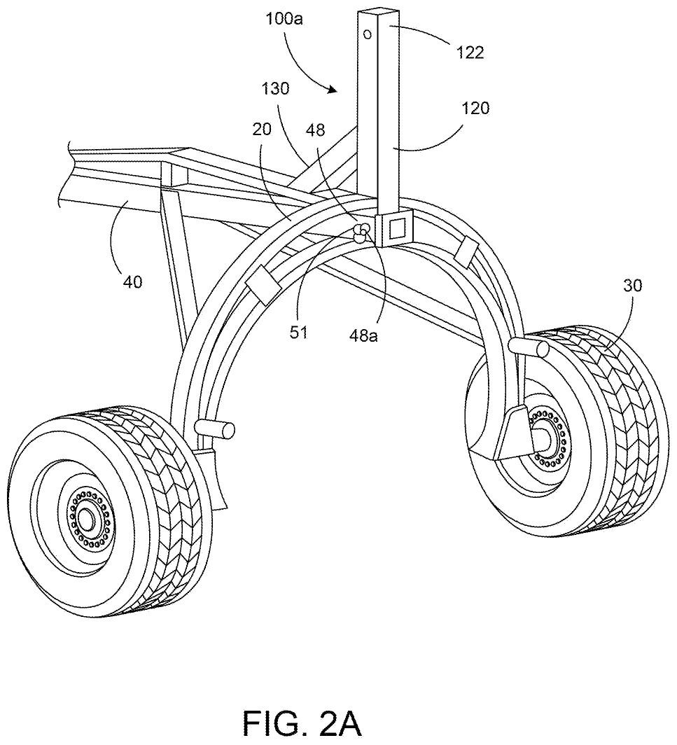

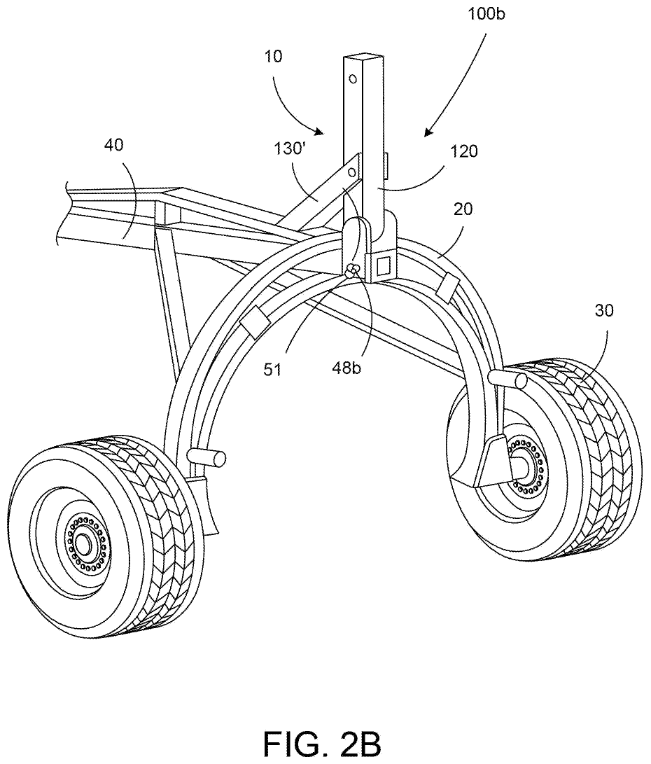

Referring to FIG. 2, a transport adapter 100 according to the invention is shown in exemplary form in order to teach how to make and use the invention. Illustrated transport adapter 100 in FIG. 1 is configured to be installed in place of the log-handling device 50, after the log L has been released from the arch and the log-handling device 50 has been removed, for example when it is time to transport log arch 10 to a remote work site by vehicle. Adapter 100 is a generally L-shaped structure comprising a spacer arm 110 and a hitch arm 120 extending generally perpendicular to spacer arm 110, with an optional (but preferred) inner corner brace 130 extending between them to reinforce the adapter. The construction of adapter 100 may be similar to that of main beam 40 of the log arch, for example thick-walled steel tubing and plate of the type used in hitch adapters and receivers, with the arms 110, 120 and any brace 130 welded, bolted, or integrally cast together. It will be understood by those skilled in the art that the materials of the adapter and the methods used to join them may vary, provided they produce an adapter structure strong enough to support the weight of the log arch 10 as described below.

At least the free end 112 of spacer arm 110 on adapter 100 is dimensioned like square-tubed connecting tongue 52 on log-handling device 50, and is inserted into the socket 48a in the rear end 48 of main beam 40 and locked in place in the same manner, i.e. by aligning a hole 112b in the spacer arm with hole 48b in the rear frame end 48, and inserting a locking pin 51 through them. Spacer arm 110 accordingly extends generally horizontally from the frame rear end 48 as a short extension of the main beam 40, behind the plane of the arch 20 and wheels 30, when the log arch 10 is in its normal wheeled position on the ground for moving logs.

As further shown in FIG. 2, once adapter 100 is installed on the rear end 48 of the log arch via the spacer arm 110, hitch arm 120 extends generally vertically upward from the rear end 48 above the crown of arch 20, by way of example a foot (12″) or so, terminating in a free outer end 122 configured to mate with a vehicle hitch receiver.

While transport adapter 100 so far is shown as a removable attachment for the log arch frame, swappable with a log handling device such as 50 removably attached to the rear end of the frame, it would also be possible to more-permanently attach or integrally form adapter 100a on the rear end 48 of the log arch frame, for example by welding or bolting the adapter to the upper side of rear end 48 (above the log-handling device socket 48a) so that hitch arm 120 is an essentially permanent vertical extension of the rear end 48. Even more preferable would be to hingedly mount the adapter transport adapter 100b to rear end 48, so that it could be folded down out of the way when not in use. (FIG. 2B).

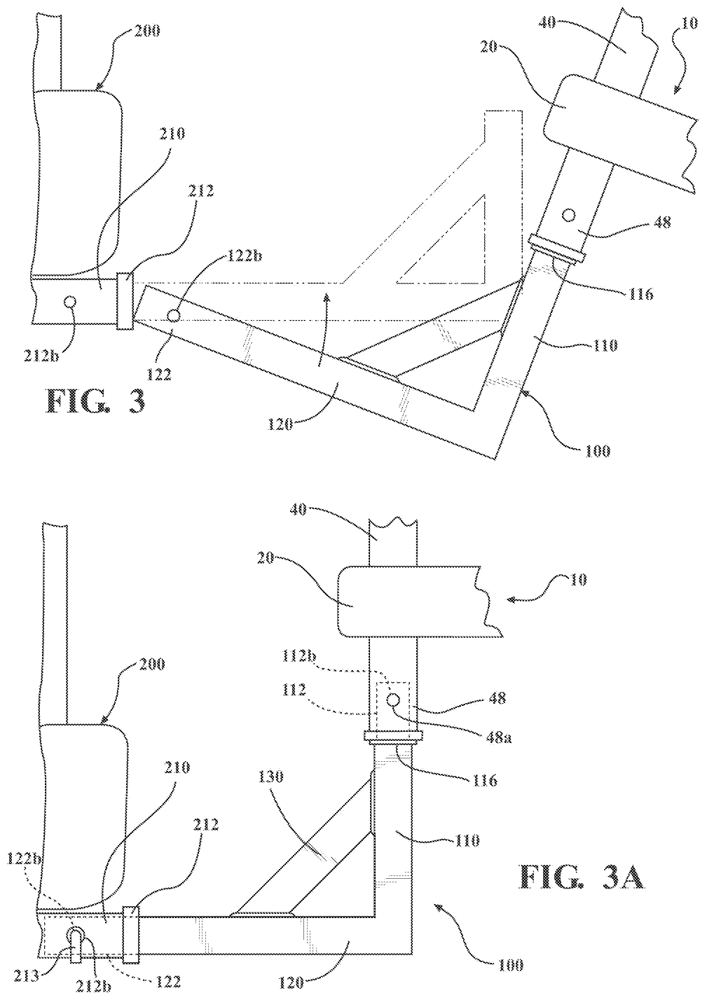

FIG. 3 shows the adapter-equipped log arch 10 of FIG. 2 positioned near the hitch end of a transport vehicle 200, for example a pickup truck, with the rear end 48 and frame arch 20 facing the truck and the main beam 40 of the now-empty log arch 10 extending away from the truck and rotated upwardly to position the hitch arm 120 more-horizontally near the empty hitch receiver 210 on the vehicle. Hitch receiver 210 may be the standard square-socket tubing commonly used on pickup trucks, with an open socket end 212 configured to removably receive a short mating piece of square tubing to which a hitch ball is attached, and to lock the hitch in place via a steel locking pin inserted through aligned holes in the mated receiver and hitch. With the hitch (not shown) removed from the socket end 212 of hitch receiver 210, hitch arm 120 of transport adapter 100 may be inserted in place of the hitch. Whatever the form of hitch receiver 210 on the vehicle, the outer free end 122 of the hitch arm 120 is configured to mate with it in place of the usual hitch.

As shown in FIGS. 3 and 3A, the height of hitch receiver 210 and the hitch arm 120 on the vertically-rotated log arch 10 may differ, due to variations in hitch height among different vehicles relative to the horizontal position of the hitch arm 120 on the log arch 10, variations in terrain, etc. In the case of a fixed-angle, non-adjustable transport adapter 100 as shown in FIGS. 1-4, where the horizontally-rotated hitch arm 120 does not perfectly line up with the height of the vehicle hitch receiver 210, the length of hitch arm 120 should be long enough so that its free end 122 can be at least partially engaged with the hitch socket 212 on the vehicle at an upward angle while the log arch wheels 30 are still on the ground. The hitch arm 120 can then be used to lever the log arch 10 up off the ground until the hitch arm 120 is level with the hitch receiver 210 by lifting/rotating the main beam 40 of the log arch 10 into a vertical position, simultaneously lifting wheels 30 off the ground. The hitch arm 120 can then be pushed straight into the hitch socket 212 until their respective locking pin holes 212b, 122b are aligned, and a standard hitch locking pin 213 can then be inserted through them and secured with a clevis in known manner (FIG. 3A).

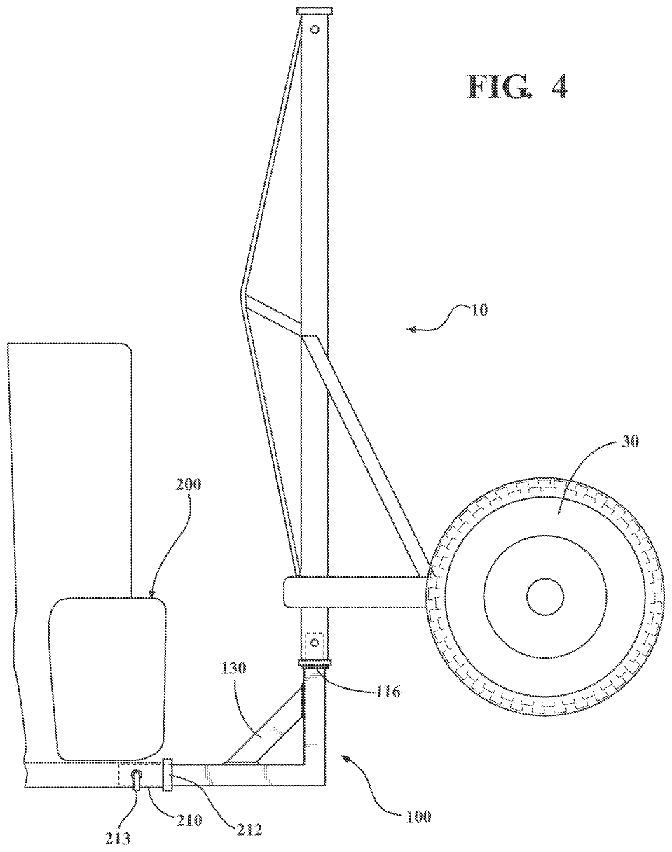

Once the log arch 10 is vertically secured to the vehicle hitch receiver 210 as described above, the log arch 10 can be transported securely behind the vehicle 200 at road speeds with the arch wheels 30 off the ground to another work site, as best shown in FIG. 4. Once arrived at the new work site, it may be helpful to remove the log arch 10 from the hitch receiver 210 with the help of a ramp, to ease the log arch out of the hitch receiver without a sudden drop.

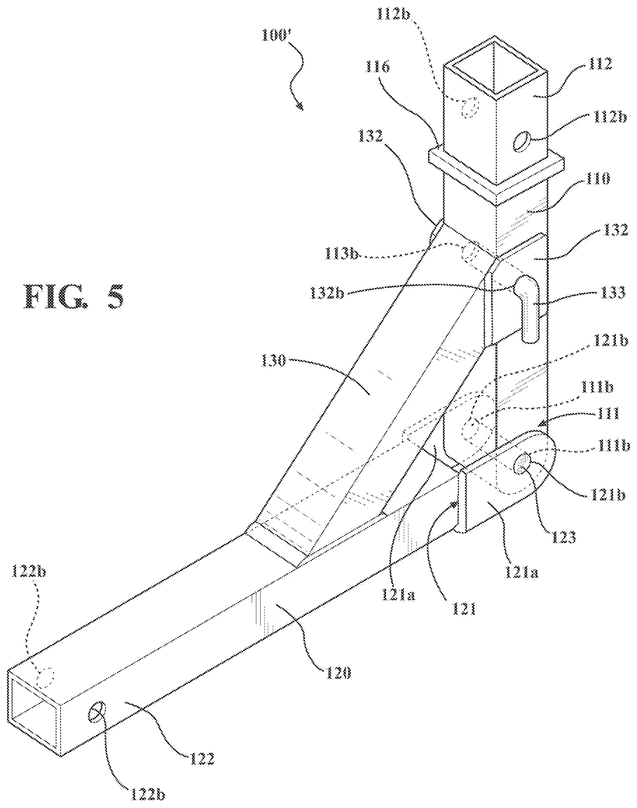

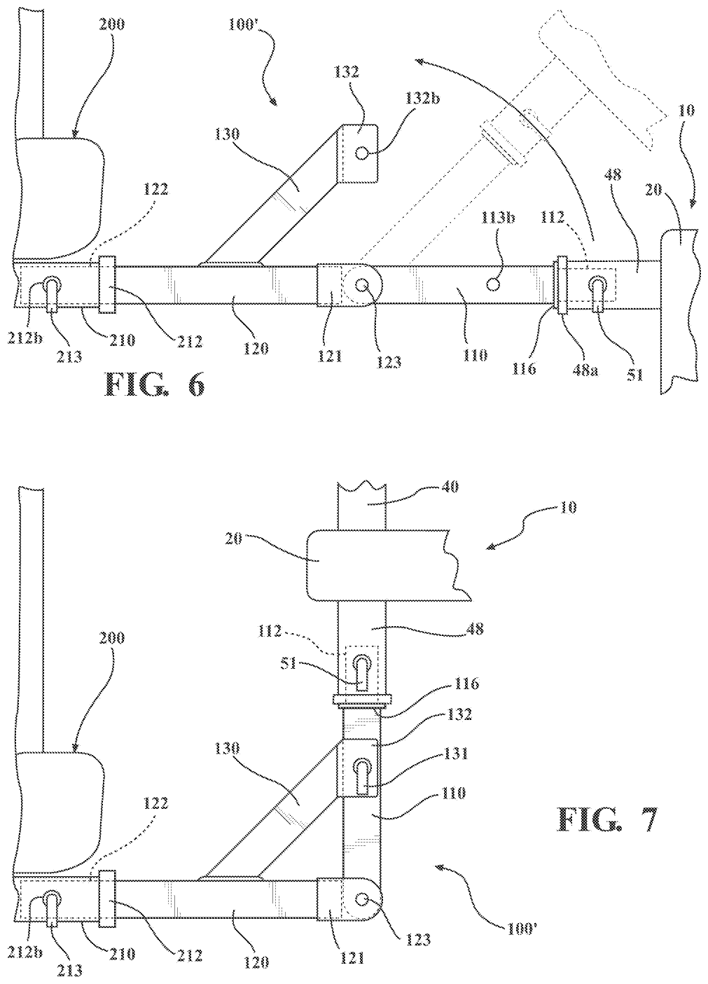

FIG. 5 shows a modified transport adapter 100′, in which the spacer arm 110 is hinged relative to the hitch arm 120 so that hitches of varying height may be more easily accommodated when initially engaging adapter 100′ with the vehicle hitch receiver 210. In the illustrated example of FIG. 5, hitch arm 120 is provided at its inner, corner end 121 with a joint formed by two spaced sidewalls or plates 121a having aligned holes 121b mounting a hinge or pivot pin 123 between them. The inner, corner end 111 of spacer arm 110 is provided with matching holes 111b through which the pivot pin 123 extends, so that the spacer arm 110 may rotate from the normal perpendicular “L” position to one or more different positions relative to the hitch arm 120, for example in an arc down into a horizontal position aligned with hitch arm 120 as shown in FIG. 6. The degree of rotation of spacer arm 110 from the vertical “L” position may be limited by a stop plate, or by engagement of the ends of the two arms, or by some other mechanism; or, alternately, the degree of rotation may extend farther, up to 180° degrees or so, with the spacer arm 110 inverted vertically downward relative to the hitch arm 120.

In the “L” position shown in solid lines in FIG. 5, the spacer arm 110 must be capable of being securely locked in place in order to support the weight of a log arch 10 mounted vertically thereon. This is achieved in the illustrated example with a brace arm 130 that removably and lockingly receives an intermediate part of the spacer arm 110 in the “L” position, via two spaced latching plates 132 on the upper end of the brace, with aligned holes 132b and matching aligned holes 113b on each side of the spacer arm 110 through which a locking pin 133 can be inserted to lock the spacer arm 110 in the “L” or vertical transport position.

Still referring to FIG. 5, another modification to the transport adapter 100′ is a reinforcing collar 116 near the upper end of the spacer arm 110, for example welded or cast therewith, located below the arch-mounting holes 112b and positioned to solidly engage the outer wall of the rear arch frame end socket 48a when the adapter 100′ is installed on the log arch as described above in FIGS. 2-4. It will be understood that collar 116 could also be applied to the spacer arm 110 on the non-adjustable adapter 100 of FIGS. 2-4, as shown in FIGS. 3 and 4.

As shown in FIG. 6, the angle-adjustable adapter 100′ may be first installed via the hitch arm 120 into the hitch receiver 210 on the vehicle 200. The adjustable spacer arm 110 may then be unlatched from the vertical “L” position by removing locking pin 133, and rotated downwardly to a convenient angle for inserting its outer end 112 into the rear frame end socket 48a on the log arch 10, while the log arch wheels 30 are still on the ground, and then locking the spacer arm 110 in place with the locking pin 51.

Referring to FIG. 7, once the spacer arm 110 is locked to the log arch 10, the log arch 10 can then be rotated upwardly via the main beam 40, similar to the manner described above in FIGS. 1-4, rotating on the corner hinge assembly 121, 123 of the adapter 100′, until the spacer arm is rotated into the vertical L-position and locked into place with pin 133. Log arch 10 can then be transported vertically behind the vehicle 200 to another work site as described above.

While the method described above in FIGS. 6 and 7 for connecting the hinged transport adapter 100′ may be preferred in some situations, it is also possible to connect adapter 100′ to the log arch 10, first, unlatch the spacer 110 and hitch arm 120 relative to one another and rotate the hitch arm 120 into initial or full engagement with the hitch receiver 210 on the vehicle, and then rotate the log arch 10 upwardly off the ground about the hinge assembly 121, 123 as described above until the spacer arm 110 can be latched in place vertically as shown in FIG. 7.

It will finally be understood that the disclosed embodiments represent presently preferred examples of how to make and use the invention but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been used to describe new and useful improvements in science and the useful arts. The scope of the invention supported by the above disclosure should accordingly be construed within the scope of what it teaches and suggests to those skilled in the art, and within the scope of any claims that the above disclosure supports in this provisional application or in any non-provisional application claiming priority to this provisional application.

1. A transport adapter for a wheeled log arch having a log arch frame with a frame rear end, a frame arch, and supporting wheels, said transport adapter comprising:
a spacer arm joined to a hitch arm in a generally L-shaped configuration;
said spacer arm comprising an outer end configured to be removably connected to said rear end of said log arch frame;
said hitch arm extending generally vertically upward from said spacer arm and log arch when said spacer arm is connected to said rear end of said log arch, and said log arch is generally horizontal supported on said wheels; wherein,
said hitch arm has an outer end configured to be removably connected to a vehicle hitch receiver in a generally horizontal orientation when said log arch is rotated to a and supported in a generally vertical position on the end of said spacer arm with said log arch wheels off the ground.

2. The transport adapter of claim 1 in which said spacer arm and said hitch arm are integral with each other, forming an integral one piece generally “L” shaped transport adapter.

3. The transport adapter of claim 2 in which said spacer arm is permanently attached to said rear end of said log arch frame.

4. The transport adapter of claim 3 in which said spacer arm is hingedly attached to said rear end of said log arch frame, whereby it can be folded out of the way when not in use.

5. The transport adapter of claim 1 in which said spacer arm is hinged relative to said hitch arm; said hinge being releasably lockable so that when locked said spacer arm and said hinge arm are generally perpendicular to one another, but when unlocked can be adjustable positioned relative to one another, whereby when said spacer arm is connected to said rear end of said log arch supported on said log arch wheels, the relative position of said hitch arm can be readily varied so that vehicle hitches of varying heights may be more easily accommodated when initially engaging said transport adapter 100′ with said vehicle hitch receiver; and whereby when said hitch arm is engaged with said vehicle, said log arch can be pivoted up into a generally vertical position with said wheels off the ground, and locked in that position by said transporter lock.

6. A method for transporting a log arch having a rear wheeled frame arch and a forward hauling beam, said method comprising:
providing a transport adapter having a spacer arm joined to a hitch arm in a generally L-shaped configuration; said spacer arm comprising an outer end configured to be removably connected to the rear end of said log arch frame; said hitch arm extending generally vertically upward from said spacer arm and log arch when said spacer arm is connected to said rear end of said log arch, and said log arch is generally horizontal supported on said wheels; wherein said hitch arm has an outer end configured to be removably connected to a vehicle hitch receiver;
connecting said spacer arm of said transport adapter to the rear end of said log arch frame to be transported, with said hitch arm extending generally vertically upright from said spacer arm;
providing a transport vehicle with a vehicle hitch receiver;
positioning said log arch as supported on its wheels with said upright hitch arm positioned near said transport vehicle hitch receiver;
rotating said log arch to a generally vertical upright position with said open end of said hitch arm facing said vehicle hitch receiver;
moving said hitch arm into engagement with said vehicle hitch receiver, whereby said log arch can be transported with said log arch wheels off the ground, thereby facilitating rapid transport without risking damage to said log arch wheels and their axles.

7. The method of claim 6 wherein the transport adapter provided is permanently attached to the rear of said log arch to be transported, whereby said step of connecting said adapter to said log arch can be omitted.

8. The method of claim 7 in which said transporter adapter transport provided has said spacer arm hinged to said hitch arm, said hinge being releasably lockable so that when locked said spacer arm and said hinge arm are generally perpendicular to one another, but when unlocked can be adjustably positioned relative to one another;
said method step of positioning said log arch spacer arm near said transport vehicle hitch receiver being performed with said hinge being unlocked and said hitch arm being pointed toward said transport vehicle hitch receiver;
moving said log arch toward said vehicle hitch until said hitch arm engages said vehicle hitch receiver;
thereafter rotating said log arch into a generally vertically position and locking said hinge to retain said log arch in said generally vertical position with said log arch wheels off the ground.

9. The method of claim 6 in which said transporter adapter transport provided has said spacer arm hinged to said hitch arm, said hinge being releasably lockable so that when locked said spacer arm and said hinge arm are generally perpendicular to one another, but when unlocked can be adjustable positioned relative to one another;
said method step of positioning said log arch spacer arm near said transport vehicle hitch receiver being performed with said hinge being unlocked and said hitch arm being pointed toward said transport vehicle hitch receiver;
moving said log arch toward said vehicle hitch receiver until said hitch arm engages said vehicle hitch receiver;
thereafter rotating said log arch into a generally vertically position and locking said hinge to retain said log arch in said generally vertical position with said log arch wheels off the ground.
